(19) United States
(12) Patent Application Publication
(10) Pub. No.: US 2005/0028722 A1
(43) Pub. Date: Feb. 10, 2005

(54) Flag for motor vehicles and the like

(76) Inventor: Luke J. Arntz, Vestaburg, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/885,833

(22) Filed: Jul. 7, 2004

Related U.S. Application Data
(60) Provisional application No. 60/486,671, filed on Jul. 11, 2003.

(51) Int. Cl. G09F 17/00

(52) U.S. Cl. 116/173

(57) ABSTRACT

A flag assembly for mounting a flag to the rearview mirror of a motor vehicle includes an elongated pole adapted to support a flag in a generally upright position. The pole defines upper and lower ends, and a flag is secured to the pole. The flag assembly also includes a bracket configured to secure the pole to a mirror assembly of a motor vehicle in a generally upright position. The pole is secured to the bracket, and the bracket includes a rigid member extending generally transverse to the pole. The rigid member has an opening therethrough, and the bracket includes a connector received in the opening to secure the flag assembly to a mirror assembly of a motor vehicle.

### CROSS-REFERENCE TO RELATED APPLICATION

The present application claims the benefit of U.S. Provisional Patent Application No. 60/486,671, filed Jul. 11, 2003, entitled FLAG FOR MOTOR VEHICLES AND THE LIKE, the entire contents of which is hereby incorporated herein by reference.

### BACKGROUND OF THE INVENTION

Various flags for mounting to motor vehicles have been developed. One type of known flag includes a bracket arrangement that fits over the upper edge of a vehicle window, such that the flag is retained in position when the window is in the closed position. Such mounting arrangements do not generally permit the window to be opened while the flag is in place if the vehicle is in motion, and provide a relatively temporary mounting arrangement. Other known flag mounting arrangements also may include suction cups or the like that permit the base of the flag assembly to be attached to the surface of a vehicle window. Alternately, known flag mounting arrangements attach to a vehicle antenna for relatively temporary use.

### SUMMARY OF THE INVENTION

One aspect of the present invention is a flag assembly for mounting a flag to the rearview mirror of a motor vehicle. The flag assembly includes an elongated pole adapted to support a flag in a generally upright position. The pole defines upper and lower ends, and a flag is secured to the pole. The flag assembly also includes a bracket configured to secure the pole to a mirror assembly of a motor vehicle in a generally upright position. The pole is secured to the bracket, and the bracket includes a rigid member extending generally transverse to the pole. The rigid member has an opening therethrough, and the bracket includes a connector received in the opening to secure the flag assembly to a mirror assembly of a motor vehicle.

Another aspect of the present invention is a combination rearview mirror and flag. A rearview mirror assembly includes a mirror support structure adapted to be mounted to a motor vehicle, and a mirror is attached to the mirror support structure. A flag assembly includes a generally upright pole secured to the mirror support structure, and a flag is secured to the pole.

Yet another aspect of the present invention is a flag assembly for mounting a flag to the rearview mirror of a motor vehicle. The flag assembly includes an elongated pole adapted to support a flag in a generally upright position. The pole defines upper and lower ends, and a flag is secured to the pole. The flag assembly further includes a bracket assembly configured to secure the pole to a mirror assembly of a motor vehicle in a generally upright position. The bracket assembly includes a clamp secured to the pole adjacent the lower end of the pole. The clamp includes first and second clamping members that are movable relative to one another, and a movable member operably interconnecting the first and second clamping members such that a component of a vehicle mirror assembly can be clamped between the first and second clamping members to thereby secure the flag assembly to a mirror assembly.

These and other features, advantages, and objects of the present invention will be further understood and appreciated by those skilled in the art by reference to the following specification, claims, and appended drawings.

### BRIEF DESCRIPTION OF THE DRAWINGS

FIG. 1 is a partially schematic side elevational view of a truck incorporating a flag according to the present invention;

FIG. 2 is a partially fragmentary perspective view of a flag mounted to the mirror structure of a truck;

FIG. 3 is a fragmentary perspective view of a lower portion of the flag of FIG. 2;

FIG. 4 is a fragmentary perspective view of the flag of FIG. 2 showing a C-clip utilized to retain the flag to the pole;

FIG. 5 is a fragmentary, cross-sectional view taken along the line V-V; FIG. 4;

FIG. 6 is a fragmentary perspective view of a second embodiment of a bracket for mounting the flag of the present invention;

FIG. 7 is a partially fragmentary, perspective view of a flag according to a third embodiment of the present invention which includes a clamp for mounting the flag to the mirror structure of a vehicle;

FIG. 8 is a partially fragmentary, perspective view of a fourth embodiment of the present invention which includes a clamp for mounting the flag to the mirror structure of a vehicle;

FIG. 9 is a fragmentary perspective view of a flag according to a fifth embodiment of the present invention, wherein the flag attaches to a mirror that is mounted on the fender of a truck or the like;

FIG. 10 is a fragmentary, enlarged view of a portion of the flag of FIG. 9 showing the bracket that mounts the flag to the mirror structure;

FIG. 11 is a fragmentary perspective view of a sixth embodiment of a flag assembly incorporating the present invention;

FIG. 12 is an enlarged perspective view of the mounting bracket of FIG. 11;

FIG. 13 is a fragmentary perspective view of a flag assembly incorporating the present invention; and

FIG. 14 is an enlarged perspective view of the bracket of FIG. 13.

### DETAILED DESCRIPTION OF PREFERRED EMBODIMENT

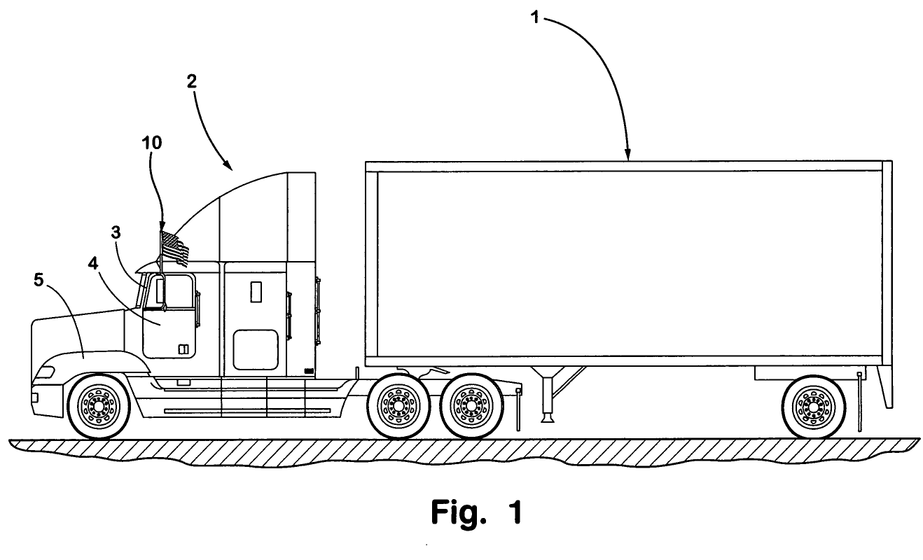

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

With reference FIG. 1, semi trailers 1 are commonly pulled by a truck tractor or cab 2. The cab 2 often includes a mirror assembly 3 mounted to the door 4 of the truck 2. Also, as described in more detail below, the cab 2 may include a mirror that is mounted to the fender 5. The flag assembly 10 of the present invention mounts to the rearview mirror assembly 3 in a generally upright position without obstructing the driver's vision.

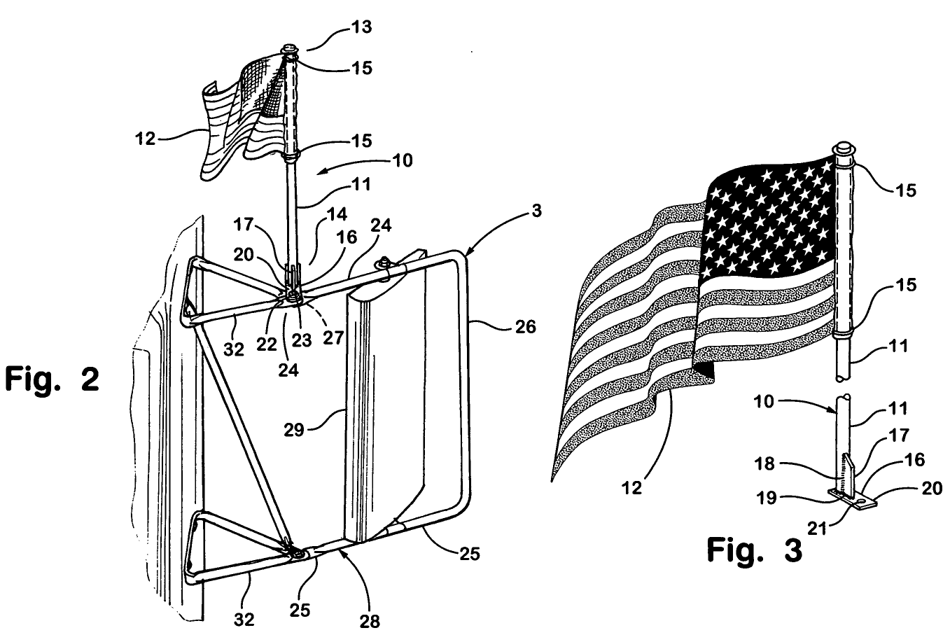

With further reference to FIG. 2, the flag assembly 10 includes an elongated pole 11 adapted to support a flag 12 made of a cloth fabric or the like in a generally upright position. The pole 11 defines an upper end 13 and a lower end 14, and the flag 12 is secured to the pole 11 by C-shaped clips 15, or the like. The flag assembly includes a bracket 16 configured to secure the pole 11 to the mirror assembly 3 of a motor vehicle in a generally upright position. In the illustrated example, a gusset 17 (see also FIG. 3) is welded to the pole 11 at 18. Gusset 17 is also welded to a rigid member 20 at 19. Rigid member 19 extends generally transverse to the pole 11, and is preferably fabricated from a metal plate or the like. The plate 20 has an opening 21 therethrough, and a connector such as a screw or bolt 22 is received in the opening 21 to secure the flag assembly 10 to the mirror assembly 3. Rearview mirror assemblies 3 commonly include an upper cross member 24, lower cross member 25, and vertical member 26. The upper cross member 24 commonly includes an opening 23 therethrough that receives the bolt or screw 22, such that a nut 27 can threadably engage a bolt 22 to rigidly secure the flag assembly 10 to the mirror assembly 3. The members 24, 25, and 26 together form a mirror support structure 28 to which the rearview mirror 29 is mounted. The mirror support structure 28 illustrated in FIG. 2 generally forms an enlarged C-shaped structure that is oriented sidewardly with the ends 30 and 31 of cross members 24, 25, respectively, configured to mount to the vehicle 4 via tubular brackets 32. Although the form of the mirror structure 3 may vary somewhat from one vehicle to another, door mounted mirrors generally include an upper cross member 24 such that the flag 10 can be mounted to a wide variety of vehicles.

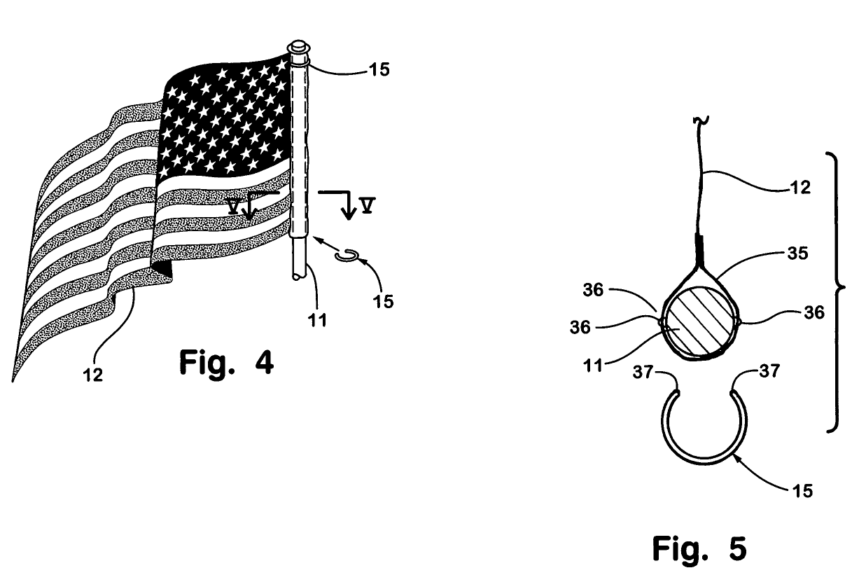

With further reference to FIGS. 4 and 5, flag 12 is of a conventional construction, and includes an elongated looped over portion 35 that fits around the flagpole 11. In the illustrated example, the pole 11 includes two pairs of protrusions 36 on opposite sides of pole 11. C-clips 15 are made of a polymer material, such that the ends 37 can be flexed outwardly away from one another, thereby permitting the C-clip 15 to fit around the pole 11, and the loop portion 35 of flag 12. The protrusions 36 ensure that the clips 15 do not shift vertically, and the clips 15 retain the flag 12 to the pole 11. In the illustrated example, protrusions 36 are formed by welding a small section of rod or other material to the pole 11. Although a wide variety of materials could be utilized to form the pole 11 and bracket 16, in the illustrated example these components are made from aluminum to provide a lightweight rigid structure that is also corrosion resistant.

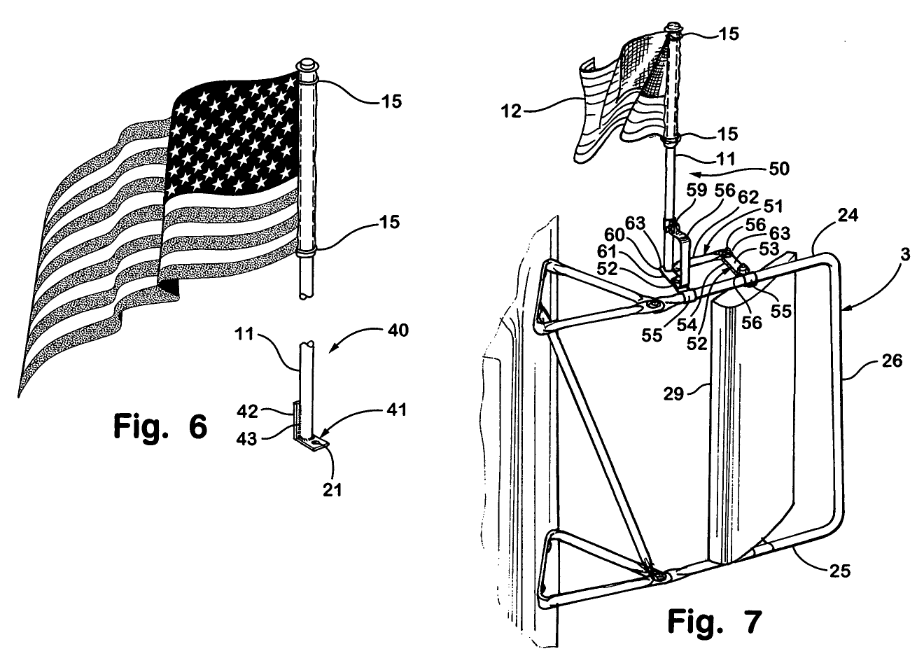

With further reference to FIG. 6, a second embodiment 40 of the flag assembly includes a flag 12 that is connected to a pole 11 by C-clips 15 in substantially the same manner as described above in connection with the first embodiment of the flag assembly. However, the flag assembly 40 utilizes an angle member 41 cut from conventional elongated angled stock, and the pole 11 is welded to the upper leg 42 of angle member 41 at 43. An opening 21 permits the flag assembly 40 to be secured to a mirror support structure 28 in substantially the same manner as the flag assembly 10 described in detail above in connection with FIG. 2.

With further reference to FIG. 7, a third embodiment 50 of the flag assembly includes a flag 12 that is secured to a pole 11 by C-clips 15 in substantially the same manner as described above. However, the third embodiment 50 of the flag assembly includes a bracket assembly 51 having a pair of strap type clamps 52 that clamp around the upper cross bar 24 of mirror support structure 28 to secure the flag assembly 50. The strap-type clamps 52 are of a conventional design, and include elongated portions 53 and 54, and a loop 55 that fits around cross member 24 of mirror support structure 28. A pair of threaded fasteners 56 extend through openings 57 in elongated portions 53 and 54, and receive threaded fasteners 56. Tightening of the threaded fasteners 56 causes the looped portions 55 to clamp tightly around the cross member 24. In a preferred embodiment, a reinforcing member 56 has a first end 59 secured to the pole 11, and a second end 60 is secured to the clamp 52 to thereby support the pole 11 in an upright position. The pole 11 includes a threaded opening (not shown) at the lower end that receives a bolt 61 to thereby secure the pole 11 to the bracket assembly 62. A bracket cross member 62 is secured to the end portions 63 of clamps 52 to further rigidify and support the flag assembly 50. The clamps 52 permit the flag assembly 50 to be secured to a generally horizontal cross member 24 of a mirror support structure 28 if the support structure 28 does not include openings permitting the embodiment of, for example, FIG. 2 to be bolted directly to the cross member 24. As discussed above, mirror support structures 3 that are mounted to the door of a truck or the like generally include a horizontal upper member 24. Although the configuration may vary somewhat from one manufacturer to another, the presence of a horizontal frame member permits the flag assembly 50 to be mounted to mirror support structures of various configurations.

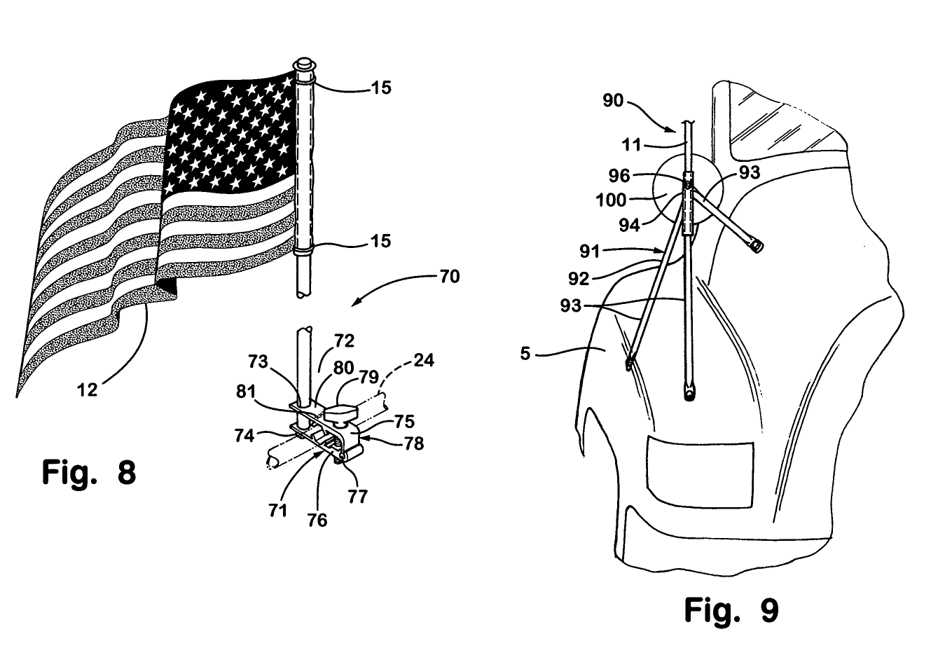

A fourth embodiment 70 of the flag assembly is illustrated in FIG. 8. The flag assembly 70 includes a flag 12 that is secured to a pole 11 by C-clips 15 in substantially the same manner as described in detail above. The lower end portion 72 of pole 11 extends through an opening 73 in a clamp 71, and a bolt 74 is received in a threaded opening (not shown) at the lower end of pole 11 to thereby secure the pole 11 to the clamp 71. Clamp 71 includes a main portion 78 that is a standard, commercially available clamp utilized to secure mirror 29 to the cross members 24 and 25. Main portion 78 includes upper member 75 and lower member 76 that are pivotally interconnected at 77, such that a threaded member 79 can be utilized to secure the clamp 71 to the cross member 24. An extension 80 is secured to the main body portion 78 by a weld 81 or the like to provide opening 73 and ensure that the flag pole 11 is rigidly secured in an upright position. The flag assembly 70 can be quickly and easily clamped to a wide variety of mirror support structures having a horizontal cross member.

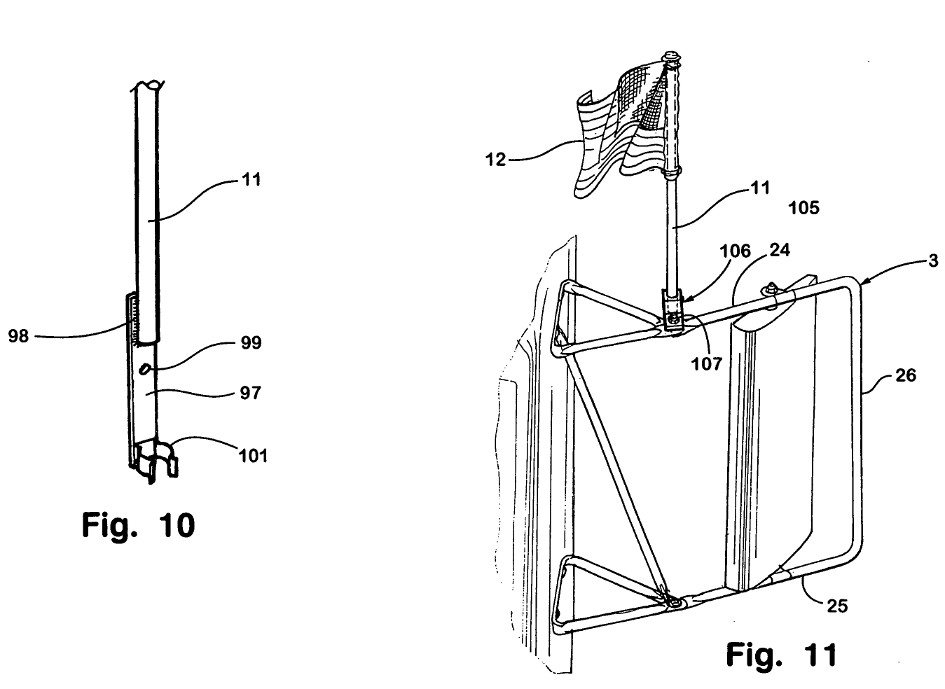

With further reference to FIGS. 9 and 10, a fifth embodiment 90 of the flag assembly can be secured to a mirror assembly 91. In contrast to the rearview mirror assembly 3 described in detail above, mirror assembly 91 is of the type that is mounted to the fender 5 of the truck via mirror support structure 92. Although the mirror support structure may vary somewhat from one vehicle to another, the mirror support structure 92 typically includes at least three rigid frame members 93 that are rigidly interconnected at an upper end 94 to form a rigid tripod structure to support the rearview mirror 95. A bolt 96 or the like is typically utilized to interconnect the three frame members 93, and to attach rearview mirror 100. The flag assembly 90 includes a flag 12 that secured to the pole 11 by C-clips 15 in substantially the same manner as described in detail above. In the illustrated example, the flag pole 11 is welded to a generally vertical plate 97 at 98 to form a rigid structure capable of securing the flag assembly 90 to the mirror support structure 92. The bolt 96 extends through an opening 99 in plate 97 to permit the flag assembly 90 to be bolted to the mirror support structure 92.

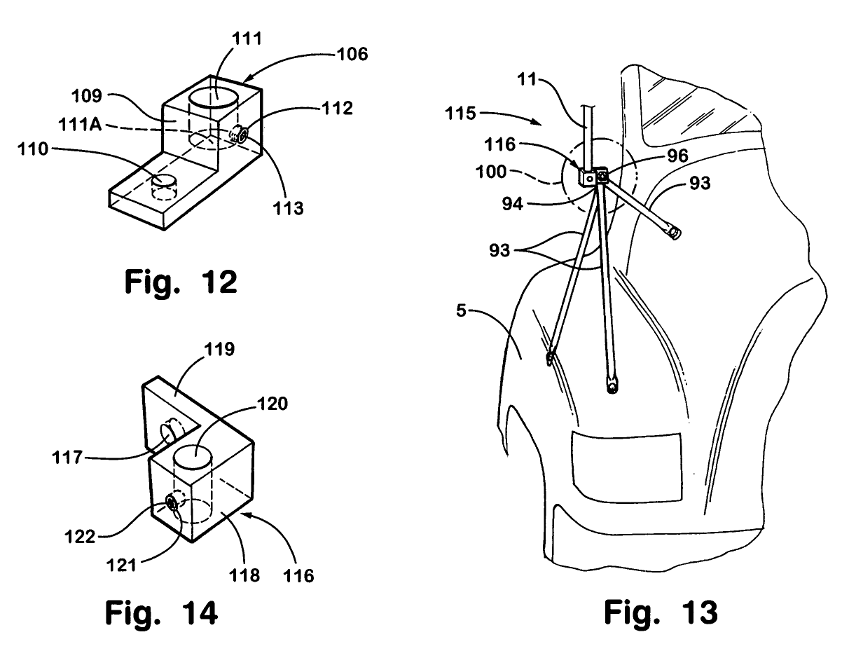

With further reference to FIG. 11, a sixth embodiment of a flag includes a bracket 106 that is secured to the upper cross member 24 of the mirror assembly 3 by a bolt 107 utilizing the same attachment location as the flag assembly 10 illustrated in FIG. 2. With further reference to FIG. 12, bracket 106 is generally L-shaped, and includes a horizontally extending portion 108, and a vertically extending portion 109. Opening 110 receives bolt 107 to secure the bracket 106 to the cross member 24 of the mirror assembly 3, and a generally vertical bore 111 receives at least a portion of the flagpole 11. Bore 111 does not extend through vertically extending portion 109, and therefore forms a bottom surface 111A. A threaded opening 112 extends generally transverse to the bore 111, and a threaded member such as set screw 113 is received therein. Tightening of the set screw 113 secures the flagpole 11 at the desired height, and also permits quick and easy removal of the flagpole 11 and flag 12 if the user does not wish to use the flag for a period of time.

With further reference to FIG. 13, a seventh embodiment 115 of the flag assembly is secured to a rearview mirror 100 of the type that is mounted to a vehicle fender 5. As discussed above, in general a bolt 96 is utilized to secure the mirror 100 to the upper ends 94 of frame members 93. The bolt 96 may be removed, and reinstalled through opening 117 (see also FIG. 14) of bracket 116. Bracket 116 is generally L-shaped, and includes leg portions 118 and 119. A bore 120 extends through leg portion 118 and receives at least a portion of the flagpole 11, and a set screw 122 is received in threaded opening 121 to secure flagpole 11 to the bracket 116 at the desired height. The bracket 116 is substantially similar to the bracket 106 of FIG. 12, except that the orientation of the bore that receives the flagpole 11 and the orientation of the threaded opening and set screw are changed to accommodate the fender mounted application. In the preferred embodiments, the opening that receives the bolt 107 or 96 is nominally 3/8 inch in diameter to accept a 3/8 inch threaded fastener. Similarly, the bore that receives the flagpole 11 is nominally 7/16 inch in diameter to receive a 7/16 inch diameter flagpole 11, and the threaded opening that receives the set screw is nominally 5/16 inch in diameter. The bracket 106 and 116 are made of aluminum or other suitable non-corrosive material.

The flag assembly of the present invention can be quickly and easily bolted or clamped to the mirror assembly of a truck. Significantly, the flag can be positioned in a manner that is readily viewed by those outside the truck, yet does not obstruct the driver's vision.

In the foregoing description, it will be readily appreciated by those skilled in the art that modifications may be made to the invention without departing from the concepts disclosed herein. Such modifications are to be considered as included in the following claims, unless these claims by their language expressly state otherwise.

1. A flag assembly for mounting a flag to the rearview mirror of a motor vehicle, comprising:
an elongated pole adapted to support a flag in a generally upright position, said pole defining upper and lower ends;
a flag secured to said pole;
a bracket configured to secure said pole to a mirror assembly of a motor vehicle in a generally upright position;
said pole secured to said bracket, said bracket including a rigid portion extending generally transverse to said pole, said rigid portion having an opening therethrough, said bracket including a connector received in said opening to secure said flag assembly to a mirror assembly of a motor vehicle.

2. The flag assembly of claim 1, wherein:
said bracket includes a reinforcing member interconnecting said rigid portion and said pole; and wherein said connector is threaded.

3. The flag assembly of claim 1, wherein:
said bracket comprises an upwardly extending portion connected with said rigid portion to define a rigid L-shaped structure, said pole connected to said upwardly extending portion.

4. The flag assembly of claim 3, wherein:
said bracket comprises a section of angle iron, and wherein said pole is welded to said angle iron.

5. The flag assembly of claim 3, wherein:
said upwardly extending portion has a generally vertical bore through at least a portion thereof, said elongated pole having a portion thereof received in said bore;
said bracket having a threaded bore extending generally transverse to said vertical bore and intersecting said vertical bore; and including:
a threaded member threadably received in said threaded bore and engaging said pole to thereby secure said pole to said bracket.

6. A combination rearview mirror and flag, comprising:
a rearview mirror assembly including a mirror support structure adapted to be mounted to a motor vehicle, said mirror support structure having vertically spaced-apart upper and lower generally horizontal frame members, each defining an outer end portion, said mirror support structure having a generally vertical frame member extending between and interconnecting said horizontal upper and lower frame members adjacent said outer end portions thereof such that said vertical frame member is spaced apart from a motor vehicle, said rearview mirror assembly including a mirror attached to said mirror support structure;
a flag assembly including a generally upright pole secured to said mirror support structure, and a flag secured to said pole.

7. The combination rearview mirror and flag of claim 6, wherein:
said flag assembly includes a clamp securing said pole to said horizontal upper frame member.

8. The combination rearview mirror and flag of claim 7, wherein:
said clamp includes a flexible strap-like portion extending around said horizontal upper frame member.

9. The combination rearview mirror and flag of claim 6, wherein:
said pole includes vertically spaced apart upper and lower protrusions; and including:
a pair of flexible C-shaped clips, each positioned adjacent said protrusions and extending around said pole and a portion of said flag to secure said flag to said pole, said clips engaging said protrusions to prevent vertical movement of said flag along said pole.

10. The combination rearview mirror and flag of claim 6, wherein:
said upper horizontal frame member has an opening therethrough and said flag assembly includes a rigid member extending transversely from said pole, said rigid member having an opening therethrough, said flag assembly having a connector extending through said openings in said upper horizontal frame member and said rigid member to secure said flag assembly to said mirror support structure.

11. A combination rearview mirror and flag, comprising:
a rearview mirror assembly including a mirror support structure adapted to be mounted to a motor vehicle, and a mirror attached to said mirror support structure;
a flag assembly including a generally upright pole secured to said mirror support structure, and a flag secured to said pole.

12. The combination rearview mirror and flag of claim 11, wherein:
said mirror support structure includes vertically spaced-apart upper and lower generally horizontal frame members, each defining an outer end portion, said mirror support structure having a generally vertical frame member extending between and interconnecting said horizontal upper and lower frame members adjacent said outer end portions thereof.

13. The combination rearview mirror and flag of claim 12, wherein:
said flag assembly includes a clamp securing said pole to said horizontal upper frame member.

14. The combination rearview mirror and flag of claim 13, wherein:
said clamp includes a flexible strap-like portion extending around said horizontal upper frame member.

15. The combination rearview mirror and flag of claim 12, wherein:
said pole includes vertically spaced apart upper and lower protrusions; and including:
a pair of flexible C-shaped clips, each positioned adjacent said protrusions and extending around said pole and a portion of said flag to secure said flag to said pole, said clips engaging said protrusions to prevent vertical movement of said flag along said pole.

16. The combination rearview mirror and flag of claim 11, wherein:
said upper horizontal frame member has an opening therethrough and said flag assembly includes a rigid portion extending transversely from said pole, said rigid portion having an opening therethrough, said flag assembly having a connector extending through said openings in said upper horizontal frame member and said rigid portion to secure said flag assembly to said mirror support structure.

17. The combination rearview mirror and flag of claim 16, wherein:
said flag assembly includes a bracket forming said rigid portion, said bracket having a generally vertical bore through at least a portion thereof, at least a portion of said pole received in said vertical bore.

18. The combination rearview mirror and flag of claim 17, wherein:
said bracket has a threaded opening extending generally transverse to said vertical bore; and including:
a threaded member received in said threaded opening and engaging said pole to retain said pole to said bracket.

19. A flag assembly for mounting a flag to the rearview mirror of a motor vehicle, comprising:
an elongated pole adapted to support a flag in a generally upright position said pole defining upper and lower ends;
a flag secured to said pole;
a bracket assembly configured to secure said pole to a mirror assembly of a motor vehicle in a generally upright position; said bracket assembly including:
a clamp secured to said pole adjacent said lower end thereof, said clamp including first and second clamping members that are movable relative to one another, and a movable member operably interconnecting said first and second clamping members such that a component of a vehicle mirror assembly can be clamped between said first and second clamping members to thereby secure said flag assembly to a mirror assembly.

20. The flag assembly of claim 19, wherein:
said movable member is threaded.

21. The flag assembly of claim 19, including:
at least one C-shaped clip extending around a portion of said flag and said pole to secure said flag to said pole.

22. The flag assembly of claim 20, wherein:
said first and second clamping members are pivotably interconnected, said pole having an end portion connected to said first clamping member, said second clamping member, engaging said pole at a second portion spaced apart from said end portion.

23. The flag assembly of claim 19, wherein:
said first and second clamping members comprise end portions of a strap clamp configured to wrap around a frame member of a mirror support assembly.
